(19) United States
(12) Patent Application Publication
(10) Pub. No.: US 2006/0003142 A1
(43) Pub. Date: Jan. 5, 2006

(54) Sound absorbing carpet and method for manufacturing the same

(75) Inventors: Kazufumi Shimizu, Narashi (JP); Osamu Tomita, Yamatokoriyamashi (JP); Shinsuke Sugie, Kitakatsuragigun (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SUMINOE TEXTILE CO., LTD., Osakashi (JP)

(21) Appl. No.: 11/136,722

(22) Filed: May 25, 2005

(30) Foreign Application Priority Data
May 28, 2004 (JP) 2004-159488
May 31, 2004 (JP) 2004-160511

(51) Int. Cl. B32B 33/00; B32B 31/12

(52) U.S. Cl. 428/95; 156/244.11

(57) ABSTRACT

A sound absorbing carpet according to the present invention is characterized in that a sound absorbing nonwoven fabric layer 6 is integrally laminated on a lower surface side of a surface skin material layer 10, and flat cross-sectional fibers are used as at least a part of fibers constituting the sound absorbing nonwoven fabric layer 6. Furthermore, another sound absorbing carpet according to the present invention is characterized in that a sound absorbing nonwoven fabric layer is integrally bonded to a lower surface side of the surface skin material layer via an adhesive film layer made of thermoplastic resin, and a part of fibers constituting the sound absorbing nonwoven fabric layer are constituted by thick fibers of 11 to 220 desitex, and the adhesive film layer is provided with a number of permeable pores formed by being contacted by the thick fibers.

This application claims priority to Japanese Patent Application No. 2004-159488 filed on May 28, 2004 and Japanese Patent Application No. 2004-160511 filed on May 31, 2004, the disclosures of which are incorporated by reference in their entireties.

### BACKGROUND OF THE INVENTION

1. Technical Field

The present invention relates to a sound absorbing carpet preferably used as an automobile carpet, and also relates to a method for manufacturing the carpet.

2. Prior Art

Conventionally, a floor carpet is disposed on an automobile floor for the purpose of, e.g., obtaining a good step feeling and preventing transmission of vibrations from the floor side. In the meantime, outside noise will be entered into an automobile. Although such noise can be reduced by the floor carpet to some extent, the reduced amount was not sufficient. Accordingly, even in a floor carpet for automobiles, it has been requested to provide a floor carpet with sound absorbing performance. As such a floor carpet, it is known that a nonwoven fabric is integrally laminated on the rear side of a carpet surface skin material (see Patent Document 1: Japanese Unexamined Laid-open Patent Publication No. 2002-200687, claim 1 and claim 3). In this structure, since nonwoven fabric is used, sound such as noise will be absorbed by the nonwoven fabric layer while passing therethrough, and therefore certain sound absorbing performance can be attained.

In the meantime, in these years, a strong demand for further enhancing quietness in an automobile indoor space to improve the comfortableness therein has been requested. In the aforementioned conventional floor carpet, however, the sound absorbing effect was far from the satisfactory level to meet such a demand. Thus, there is an urgent need to develop a carpet having excellent sound absorbing performance.

The present invention was conceived in view of the aforementioned technical background, and aims to provide a carpet capable of attaining excellent sound absorbing performance and sufficient quietness.

Other objects will be apparent from the below mentioned embodiments.

### SUMMARY OF THE INVENTION

In order to attain the aforementioned objects, the present invention provides the following means.

[1] A sound absorbing carpet, comprising:
a surface skin material layer;
a sound absorbing nonwoven fabric layer integrally laminated on a lower surface side of the surface skin material layer,
wherein flat cross-sectional fibers are used as at least a part of fibers constituting the sound absorbing nonwoven fabric layer.

[2] The sound absorbing carpet as recited in the aforementioned Item [1], wherein a flat rate of the flat cross-sectional fiber is 5 to 40%.

[3] The sound absorbing carpet as recited in the aforementioned Item [1] or [2], wherein round cross-sectional fibers and the flat cross-sectional fibers are used as fibers constituting the sound absorbing nonwoven layer, and wherein a content rate of the flat cross-sectional fibers with respect to a total amount of fibers constituting the sound absorbing nonwoven layer is 10 mass % or more but less than 100 mass %.

[4] The sound absorbing carpet as recited in the aforementioned Item [3], wherein a thickness of the round cross-sectional fiber is 1.1 to 33 decitex, and wherein a thickness of the flat cross-sectional fiber is 1.1 to 17 decitex.

[5] The sound absorbing carpet as recited in any one of the aforementioned Item [1] to [4], wherein a thickness of the sound absorbing nonwoven layer is 1 to 20 mm.

[6] The sound absorbing carpet as recited in any one of the aforementioned Items [1] to [5], wherein an amount of fibers constituting the sound absorbing nonwoven fiber layer is 80 to 1,000 g/cm².

[7] The sound absorbing carpet as recited in any one of the aforementioned Items [1] to [6], wherein water repellent agent is adhered to at least a part of fibers constituting the sound absorbing nonwoven fiber layer.

[8] The sound absorbing carpet as recited in any one of the aforementioned Items [1] to [7], wherein an adherence amount of the water repellent agent (in a dry condition) is 1 to 20 g/m².

[9] The sound absorbing carpet as recited any one of the aforementioned Items [1] to [8], wherein, as the surface skin material layer, a carpet cloth in which pile is embedded in an upper surface of a base fabric having a precoat processed lower surface is used, and wherein the surface skin material layer and the sound absorbing nonwoven fabric layer are integrally bonded via a permeable adhesive resin layer of 30 to 500 g/m² formed by melting thermoplastic resin powder.

[10] A sound absorbing carpet, comprising:
a surface skin material layer; and
a sound absorbing nonwoven fabric layer integrally bonded to a lower surface side of the surface skin material layer via an adhesive film layer made of thermoplastic resin,
wherein a part of fibers constituting the sound absorbing nonwoven fabric layer are constituted by thick fibers of 11 to 220 desitex, and
wherein the adhesive film layer is provided with permeable pores formed by being contacted by the thick fibers.

[11] The sound absorbing carpet as recited in the aforementioned Item [10], wherein a part of the thick fibers are embedded in the adhesive film layer and tangled therewith.

[12] The sound absorbing carpet as recited in the aforementioned Item [10] or [11], wherein thick fibers of 11 to 220 desitex and first fibers of 1 to 10 desitex are used as fibers constituting the sound aborbing nonwoven fabric layer.

[13] The sound absorbing carpet as recited in the aforementioned Item [12], wherein the sound absorbing nonwoven fabric layer is made of nonwoven fabric in which the thick fibers are upwardly protruded from an upper surface of a nonwoven fabric base layer formed by the thick fibers and the first fibers.

[14] The sound absorbing carpet as recited in the aforementioned Item [12] or [13], wherein a combined mass ratio of the fibers constituting the sound absorbing nonwoven layer is thick fibers/first fibers=5/95 to 99/1.

[15] The sound absorbing carpet as recited in any one of the aforementioned Items [10] to [14], wherein an amount of the sound absorbing nonwoven fiber layer is 150 to 1,000 g/m².

[16] The sound absorbing carpet as recited any one of in the aforementioned Items [10] to [15], wherein an amount of the adhesive film layer is 5 to 300 g/m².

[17] The sound absorbing carpet as recited in any one of the aforementioned Items [10] to [16], wherein the adhesive film layer contains the thermoplastic resin and filler.

[18] The sound absorbing carpet as recited in any one of the aforementioned Items [10] to [17], wherein, as the surface skin material layer, carpet cloth in which pile is embedded in an upper surface of a base fabric having a precoat processed lower surface is used.

[19] The sound absorbing carpet as recited in any one of the aforementioned Items [10] to [18], wherein a needle punched nonwoven fabric is used as the surface skin material layer.

[20] A method of manufacturing a sound absorbing carpet, the method comprising:
superimposing nonwoven fabric in which thick fabrics of 11 to 220 desitex are used as a part of fibers constituting the nonwoven fabric, an adhesive film of thermoplastic resin obtained immediately after extrusion and surface skin material in this order; and
pressing them by and between a pair of rollers.

[21] The method of manufacturing a sound absorbing carpet as recited in the aforementioned Item [20], wherein, using nonwoven fabric in which thick fibers of 11 to 220 desitex are upwardly protruded from an upper surface of a nonwoven fabric base layer formed by the thick fibers and first fibers of 1 to 10 desitex as the sound absorbing nonwoven fabric layer, the nonwoven fabric, the adhesive film and the surface skin material are pressed by and between a pair of rollers in a state in which an upwardly protruded thick fiber side is in contact with the adhesive film.

[22] The method of manufacturing a sound absorbing carpet as recited in the aforementioned Item [20] or [21], wherein a pressing roller is used as one of the pair of rollers and a cooling roller is used as the other of the pair of rollers.

According to the invention as recited in the aforementioned Item [1], since flat cross-sectional fibers are used as at least a part of fibers constituting the sound absorbing nonwoven fabric layer, excellent sound absorbing performance can be attained because of the improved diffuse reflection effect, etc. Especially, at a high frequency region exceeding 2,000 Hz, sound absorbing performance can be improved remarkably. Accordingly, quietness in a space (e.g., automobile internal space) in which this sound absorbing carpet is disposed can be attained sufficiently.

According to the invention as recited in the aforementioned Item [2], since the flat rate of the flat cross-sectional fiber is set to 5 to 40%, the sound absorbing performance can be further improved. Especially, at a high frequency region exceeding 2,000 Hz, sound absorbing performance can be improved remarkably.

According to the invention as recited in the aforementioned Item [3], since round cross-sectional fibers and the flat cross-sectional fibers are used as fibers constituting the sound absorbing nonwoven layer and a content rate of the flat cross-sectional fibers with respect to a total amount of fibers constituting the sound absorbing nonwoven layer is 10 to 70 mass %, sound absorbing performance can be further improved.

According to the invention as recited in the aforementioned Item [4], since a thickness of the round cross-sectional fiber is 1.1 to 33 decitex and a thickness of the flat cross-sectional fiber is 1.1 to 17 decitex, sufficient sound absorbing performance can be secured while keeping excellent cushion property.

According to the invention as recited in the aforementioned Item [5], since a thickness of the sound absorbing nonwoven layer is set to 1 to 20 mm, excellent sound performance can be secured while maintaining lightweight characteristic.

According to the invention as recited in the aforementioned Item [6], since an amount of fibers constituting the sound absorbing nonwoven fiber layer is set to 80 to 1,000 g/cm², sound absorbing performance can be further improved.

According to the invention as recited in the aforementioned Item [7], since the structure that water repellent agent is adhered to at least a part of fibers constituting the sound absorbing nonwoven fabric layer is employed, water permeation can be prevented by the sound absorbing nonwoven fabric layer. Accordingly, it is possible to prevent the reaching of water to the lower laying surface of this sound absorbing carpet.

According to the invention as recited in the aforementioned Item [8], sufficient water repellent performance can be attained.

According to the invention as recited in the aforementioned Item [9], adhesive strength between the surface skin material layer and the sound absorbing nonwoven fabric layer can be enhanced sufficiently. Accordingly, a sound absorbing carpet excellent in durability can be provided.

According to the invention as recited in the aforementioned Item [10], sound absorbing performance can be obtained by the resonance absorption of the adhesive film layer, and that the adhesive film layer is provided with a number of permeable pores formed by being contacted by the thick fibers of the sound absorbing nonwoven fabric layer. Therefore, excellent sound absorbing performance can be attained. Furthermore, since the thickness of the thick fiber falls within the range of 11 to 220 desitex, the permeable pores formed in the adhesive film layer allows air-permeation, but barely allows water-permeation. This gives appropriate water repellent performance to the carpet.

According to the invention as recited in the aforementioned Item [11], since a part of the thick fibers are embedded in the adhesive film layer and tangled therewith, the bonding strength can be enhanced.

According to the invention as recited in the aforementioned Item [12], since first fibers of 1 to 10 desitex are used together with the thick fibers as fibers constituting the sound aborbing nonwoven fabric layer, the sound absorbing performance can be further improved.

According to the invention as recited in the aforementioned Item [13], since the thick fibers are upwardly protruded from an upper surface of a nonwoven fabric base layer, when the thick fibers come into contact with the adhesive film layer at the time of bonding, a number of permeable pores can be formed in the adhesive film layer, resulting in further improved sound absorbing performance.

According to the invention as recited in the aforementioned Item [14], since a combined mass ratio of the fibers constituting the sound absorbing nonwoven layer is thick fibers/first fibers=5/95 to 99/1, the sound absorbing performance can be further improved.

According to the invention as recited in the aforementioned Item [15], since an amount of the sound absorbing nonwoven fiber layer is set to 150 to 1,000 g/m², the sound absorbing performance can be further improved.

According to the invention as recited in the aforementioned Item [16], an amount of the adhesive film layer is 50 to 300 g/m², sufficient bonding strength can be attained. Furthermore, when the thick fibers come into contact with the adhesive film layer at the time of bonding, a number of permeable pores can be formed in the adhesive film layer, resulting in further improved sound absorbing performance.

According to the invention as recited in the aforementioned Item [17], since the adhesive film layer contains filler, permeable pores can be more easily formed in the adhesive film layer by being contacted by the thick fibers. In other words, there is a merit that permeable pores can be more easily formed by the existence of the filler.

According to the invention as recited in the aforementioned Item [18], a carpet excellent in foot step feeling can be provided.

According to the invention as recited in the aforementioned Item [19], since a needle punched nonwoven fabric is used as the surface skin material layer, the sound absorbing performance can be further improved, and furthermore a sound absorbing carpet can be provided at low cost.

According to the invention as recited in the aforementioned Item [20], the sound absorbing carpet according to the invention as recited in the aforementioned Items [10] to [19] can be manufactured efficiently. Furthermore, in the obtained sound absorbing carpet, sound absorbing performance can be attained by the resonance absorption by the adhesive film layer. In addition, since a number of permeable pores are formed in the adhesive film layer by being contacted by the thick fibers of the sound absorbing nonwoven fabric, excellent sound absorbing performance can be obtained. Furthermore, since the thickness of the thin fiber falls within the range of 11 to 220 desitex, the permeable pores formed in the adhesive film layer allows air-permeation, but barely allows water-permeation, resulting in a carpet with appropriate water repellent performance.

According to the invention as recited in the aforementioned Item [21], since the thick fibers are upwardly protruded from an upper surface of a nonwoven fabric base layer, when the thick fibers come into contact with the adhesive film layer at the time of bonding, a number of permeable pores can be formed in the adhesive film layer. This enables manufacturing of a sound absorbing carpet with further improved sound absorbing performance.

According to the invention as recited in the aforementioned Item [22], since a pressing roller is used as one of the pair of rollers and a cooling roller is used as the other of the pair of rollers, the pressing with the pair of rollers enables integral bonding and cooling solidification of the bonding layer, thereby improving the manufacturing efficiency.

### BRIEF DESCRIPTION OF THE DRAWINGS

The aforementioned objects, other objects, features and advantages of the present invention will become more apparent by referring the preferred embodiments of the invention which will be detailed with the attached drawings.

FIG. 1 is a cross-sectional view showing an embodiment of a sound absorbing carpet according to a first invention.

FIG. 2 is a cross-sectional view showing an example of a cross-sectional shape of a flat cross-sectional fiber.

FIGS. 3A, 3B and 3C are a cross-sectional view showing another example of a cross-sectional shape of a flat cross-sectional fiber, respectively.

FIG. 4 is a cross-sectional view showing an embodiment of a sound absorbing carpet according to a second invention.

FIG. 5 is a cross-sectional view showing the nonwoven fabric used in manufacturing the sound absorbing carpet according to the second invention.

FIG. 6 is an explanatory view showing the manufacturing method of the sound absorbing carpet according to the second invention.

### DETAILED DESCRIPTION OF THE PREFERRED EMBODIMENTS

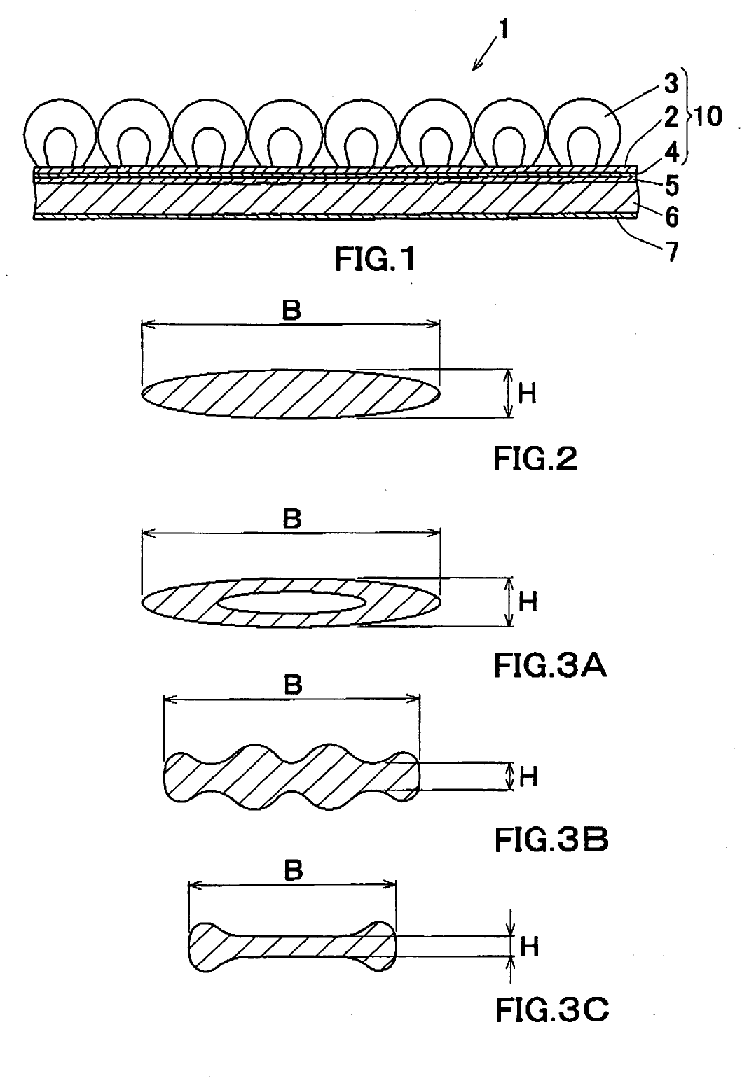

An embodiment of a sound absorbing carpet 1 according to a first invention is shown in FIG. 1. In FIG. 1, the reference numeral “10” denotes a surface skin material layer, “5” denotes a permeable adhesive resin layer, and “6” denotes a sound absorbing nonwoven fabric layer.

The surface skin material layer 10 includes a base fabric 2, pile 3 embedded on the upper surface of the base fabric 2 and a precoat layer 4 formed on the lower surface of the base fabric 2 by precoat processing, and has air permeability. The surface skin material layer 10 and the sound absorbing nonwoven fabric layer 6 are integrally bonded via the permeable adhesive resin layer 5. To the lower surface of the sound absorbing nonwoven fabric layer 6, a slip preventing resin layer 7 is provided. As at least a part of fibers constituting the sound absorbing nonwoven fabric layer 6, flat cross-sectional fibers are used. According to the sound absorbing carpet 1 of this embodiment, the sound absorbing performance of the carpet 1 can be improved by the existence of the flat cross-sectional fibers.

In this first invention, as the base fabric 2, spanbond nonwoven fabric, needle punched nonwoven fabric and woven fabric can be exemplified, though it is not specifically limited. Among these, it is preferable to use spanbond nonwoven fabric. In this case, a number of voids communicating the front and rear sides of the fabric can be secured even if the fabric is subjected to precoat processing (stitching protection processing), resulting in excellent permeability, which in turn can further improve the sound absorbing performance.

It is preferable that the amount of the base fabric 2 is set to 80 to 150 g/m². If it is less than 80 g/m², it becomes difficult to embed the pile 3 in the base fabric 2 in a stably supported manner, and therefore it is not preferable. If it exceeds 150 g/m², sufficient permeability cannot be secured, resulting in deteriorated sound absorbing performance, and therefore it is not preferable.

Furthermore, the amount of the pile 3 is preferably set so as to fall within the rage of 250 to 2,000 g/m².

The precoat layer 4 is a resin layer formed by applying emulsion or solution of synthetic resin or rubber. The synthetic resin adhesion amount (in a dry condition) in this precoat layer 4 is preferably set to 30 to 150 g/m². If it is less than 30 g/m², sufficient pile pulling strength cannot be obtained, resulting in easy loss of pile, and therefore it is not preferable. If it exceeds 150 g/m², sufficient permeability cannot be secured, resulting in deteriorated sound absorbing performance, and therefore it is also not preferable.

It is necessary that flat cross-sectional fibers each having a flat cross-sectional shape are used as at least a part of fibers constituting the sound absorbing nonwoven fabric layer 6. By using the flat cross-sectional fibers, due to the contribution to improvement of diffuse reflection effects, etc., by the flat cross-sectional fibers, the sound absorbing performance of the carpet 1 can be improved. The sound absorbing performance can be improved from a low frequency region to a high frequency region. Especially, the sound absorbing performance can be remarkably improved at a high frequency region exceeding 2,000 Hz.

It is preferably that the flat rate of the flat cross-sectional fiber is 5 to 40%. If it is less than 5%, the productivity deteriorates, and therefore it is not preferable. If it exceeds 40%, sufficient sound absorbing performance improving effect cannot be attained, and therefore it is also not preferable. The flat rate is a numeric value defined by the following formula:
Flat rate (%)=H/B×100
where ‘B’ is a major axis of the flat cross-sectional fiber and ‘H’ is a minor axis of the flat cross-sectional fiber as shown in FIG. 2.

As the flat cross-sectional fiber, a hollow fiber as shown in FIG. 3A can also be used. Alternative examples of the cross-sectional shape of the flat cross-sectional fiber are shown in FIGS. 3B and 3C.

As fibers constituting the sound absorbing nonwoven fabric layer 6, it is preferable to use both the flat cross-sectional fibers and round cross-sectional fibers. In this case, it is preferable that the content rate of the flat cross-sectional fibers with respect to the entire amount of fibers constituting the sound absorbing nonwoven fabric layer 6 is set so as to fall within the range of 10 to 70 mass %. If it is less than 10 mass %, sufficient sound absorbing performance improving effect cannot be obtained, and therefore it is not preferable. If it exceeds 70 mass %, it becomes difficult to perform carding, resulting in deteriorated productivity, and therefore it is not preferable.

In the case of employing a structure in which both the round cross-sectional fibers and the flat cross-sectional fibers are used as fibers constituting the sound absorbing nonwoven fabric layer 6, it is preferable that the thickness of the round cross-sectional fiber is set to 1.1 to 33 desitex and the thickness of the flat cross-sectional fiber is set to 1.1 to 17 desitex. By setting them within the ranges, sufficient sound absorbing performance can be secured while keeping excellent cushioning characteristic.

The thickness of the sound absorbing nonwoven fabric layer 6 is preferably set to 1 to 20 mm. If it is less than 1 mm, sufficient sound absorbing effect cannot be obtained. On the other hand, if it exceeds 20 mm, for example, the height in an automobile inner space decreases, which makes it difficult to obtain sufficient comfortableness as an automobile inner space, and therefore it is not preferable. Among other things, it is preferable that the thickness of the sound absorbing nonwoven fabric layer 6 is set to 1.5 to 15 mm.

The amount of fibers constituting the sound absorbing nonwoven fabric layer 6 is preferably set to 80 to 1,000 g/m². If it is less than 80 g/m², sufficient sound absorbing effect cannot be obtained, and therefore it is not preferable. If it exceeds 1,000 g/m², it becomes difficult to secure sufficient permeability, resulting in deteriorated sound absorbing effect, and therefore it is not preferable. Among other things, it is more preferable that the amount of fibers constituting the sound absorbing nonwoven fabric layer 6 is set to 150 to 1,000 g/m².

As the nonwoven fabric configuration of the sound absorbing nonwoven fabric layer 6, needle punched nonwoven fabric and spanbond nonwoven fabric can be exemplified, though it is not specifically limited.

In the first invention, it is preferable to employ such structure that water repellent agent is adhered to at least a part of fibers constituting the sound absorbing nonwoven fiber layer 6. By employing such a structure, it becomes possible to prevent water from permeating the sound absorbing nonwoven fabric layer 6, which gives water interception performance. For example, in cases where this sound absorbing carpet 1 is applied to an automobile floor carpet, it is possible to prevent water such as raindrops brought into an automobile from reaching a metal plate constituting a floor on which the sound absorbing carpet 1 is disposed. Therefore, oxidization or corrosion of the metal plate can be prevented. As the repellent agent, though it is not specifically limited, fluorine series water repellent agent can be exemplified.

It is preferable that the adherence amount of the water repellent agent (in a dry condition) is set to 1 to 20 g/m². If it is less than 1 g/m², sufficient water interception performance cannot be secured, and therefore it is not preferable. On the other hand, if it exceeds 20 g/m², it becomes difficult to secure sufficient air-permeability of the sound absorbing nonwoven fabric layer 6, resulting in deteriorated sound absorbing effect, and therefore it is not preferable. Among other things, it is more preferable that the amount of the water repellent agent (in a dry condition) is set to 2 to 15 g/m².

As a method of making the water repellent agent adhere to the fibers constituting sound absorbing nonwoven fabric layer 6, although it is not specifically limited, examples include a method of splaying a water solution of water repellent agent to nonwoven fabric, a method of dipping nonwoven fabric in a water solution of water repellent agent, and a roller coating method in which water repellent agent is applied to nonwoven fabric by moving the nonwoven fabric on a roller which is partially dipped in a bath containing a water solution of the water repellent agent while making the nonwoven fabric contact to the roller.

It is preferable that the permeable adhesive resin layer 5 is an adhesive layer formed by melting thermoplastic resin powder. As the thermoplastic resin powder, although it is not specifically limited, it is preferable to use polyolefin series resin. As such polyolefin series resin, polyethylene, polypropylene, and APAO can be exemplified. The applied amount of this thermoplastic resin power, i.e., the amount of the permeable adhesive resin layer 5, is preferably set to 30 to 500 g/m². If it is less than 30 g/m², sufficient bonding strength cannot be obtained, and therefore it is not preferable. If it exceeds 500 g/m², sufficient air-permeability cannot be obtained to thereby cause a deterioration of sound absorbing performance, and therefore it is not preferable.

It is preferable that the average particle diameter of the thermoplastic resin powder is 90 to 1,000 μm. If it is less than 90 μm, the powder easily stirs up to deteriorate the working environment at the time of manufacturing the powder, and therefore it is not preferable. If it exceeds 1,000 μm, the thermoplastic resin power becomes hard to be molten, resulting in insufficient bonding strength, and therefore it is not preferable.

The slip preventing resin layer 7 can be formed by, for example, applying the resin by a roller coating method or a spraying method. The amount of slip preventing resin layer 7 is preferably set to 50 to 150 g/m².

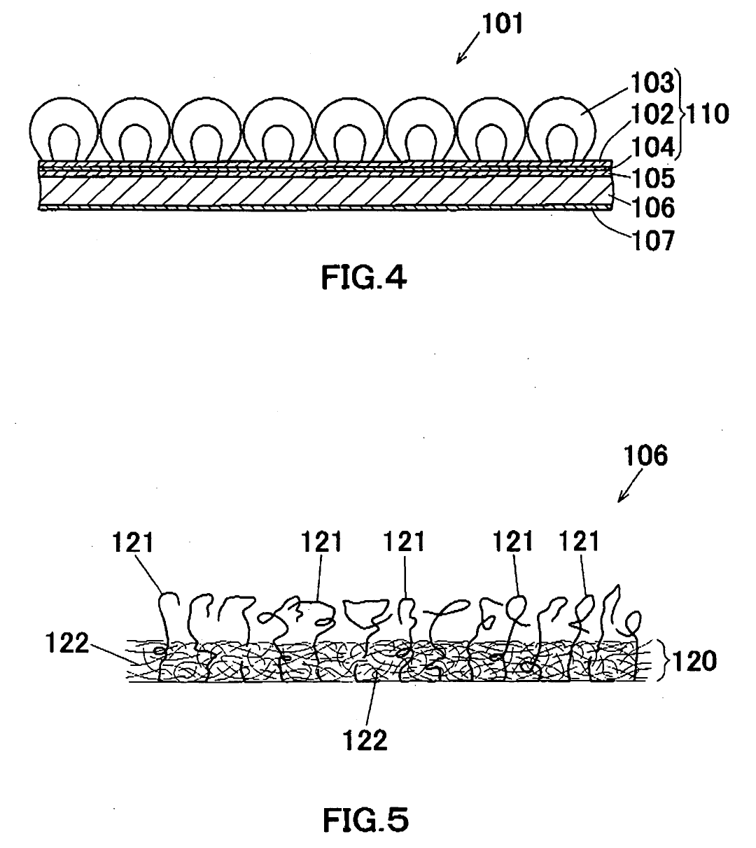

An embodiment of a sound absorbing carpet 101 according to a second invention is shown in FIG. 4. In FIG. 4, the reference numeral “110” denotes a surface skin material layer, “105” denotes a permeable adhesive resin layer, and “106” denotes a sound absorbing nonwoven fabric layer.

The surface skin material layer 110 includes a base fabric 102, pile 103 embedded on the upper surface of the base fabric 102 and a precoat layer 104 formed on the lower surface of the base fabric 102 by precoat processing, and has air-permeability. The surface skin material layer 110 and the sound absorbing nonwoven fabric layer 106 are integrally bonded via the adhesive resin layer 105. To the lower surface of the sound absorbing nonwoven fabric layer 106, a slip preventing resin layer 107 is provided.

As a part of fibers constituting the sound absorbing nonwoven fabric layer 106, thick fibers of 11 to 220 desitex are utilized. In this embodiment, the sound absorbing nonwoven fabric 106 is nonwoven fabric having a nonwoven fabric base layer 120 made of thick fibers 121 of 11 to 220 desitex and first fibers of 1 to 10 desitex in which the thick fibers 121 upwardly extend from the upper surface of the nonwoven fabric base layer 120 (see FIG. 5). As shown in FIG. 5, the upwardly extended thick fibers 121 do not extend linearly, but extend in a variously curved or bent manner. Thus, the upper surface of the sound absorbing nonwoven fabric layer 106 is formed into a convexo-concave surface by the upwardly extended thick fibers 121.

The adhesive film layer 105 is provided with a number of air-permeable pores formed when the thick fibers 121 of the sound absorbing nonwoven fabric layer 106 come into contact with the adhesive film layer 105 at the time of superimposing them for integral bonding.

Thus, in the sound absorbing carpet 101, sound such as noise can be absorbed by the adhesive film layer 105. Furthermore, the adhesive film layer 105 has permeability due to a number of permeable pores formed by being contacted by the thick fibers 121. Therefore, by these synergetic effects, excellent sound absorbing performance can be obtained. Furthermore, since the thickness of the thick fiber 121 is set to 11 to 220 desitex, the permeable pores formed in the adhesive film layer 105 allows air-permeation, but barely allows water-permeation, which gives appropriate water repellent performance to the carpet. In addition, in this embodiment, the thick fibers 121 are upwardly protruded from the upper surface of the nonwoven fabric base layer 120, in other words, the thick fibers 121 are upwardly protruded from the nonwoven fabric base layer 120. Therefore, there are merits that a number of permeable pores can be assuredly formed in the adhesive film layer 105, resulting in further improved sound absorbing performance.

In the second invention, as the base fabric 102, spanbond nonwoven fabric, needle punched nonwoven fabric and woven fabric can be exemplified, though it is not specifically limited. Among these, it is preferable to use spanbond nonwoven fabric. In this case, a number of voids communicating the front and rear sides of the fabric can be secured even if the fabric is subjected to precoat processing (stitching protection processing), resulting in excellent permeability, which in turn can further improve the sound absorbing performance.

It is preferable that the amount of the base fabric 102 is set to 90 to 150 g/m². If it is less than 90 g/m², it becomes difficult to embed the pile 103 in the base fabric 102 in a stably supported manner, and therefore it is not preferable. If it exceeds 150 g/m², sufficient permeability cannot be secured, resulting in deteriorated sound absorbing performance, and therefore it is not preferable.

Furthermore, the amount of the pile 103 is preferably set so as to fall within the rage of 300 to 2,000 g/m².

The precoat layer 104 is a resin layer formed by applying emulsion or solution of synthetic resin or rubber. The synthetic resin adhesion amount (in a dry condition) in this precoat layer 104 is preferably set to 50 to 150 g/m². If it is less than 50 g/m², sufficient pile pulling strength cannot be obtained, resulting in easy loss of pile, and therefore it is not preferable. If it exceeds 150 g/m², sufficient permeability cannot be secured, resulting in deteriorated sound absorbing performance, and therefore it is also not preferable.

As a part of fibers constituting the sound absorbing nonwoven fabric layer 106, it is necessary that the thick fiber 121 of 11 to 220 desitex are used. By using such thick fibers, when the surface skin material layer 110 and the sound absorbing nonwoven fabric layer 106 are superimposed via the adhesive film layer 105 for integral bonding, the thick fibers 121 of the sound absorbing nonwoven fabric layer 106 come into contact with the adhesive film layer 105, thereby forming a number of permeable pores in the adhesive film layer 105.

Among other things, as the fiber constituting the sound absorbing nonwoven fabric layer 106, it is preferable to employ the structure using the thick fibers 121 of 11 to 220 desitex and the first fibers 122 of 1 to 10 desitex. Using the first fibers of 1 to 10 desitex further improves the sound absorbing performance.

The combined mass ratio of the fibers constituting the sound absorbing nonwoven layer 106 is preferably set to “thick fibers/first fibers”=“5/95 to 99/1.” If the use rate of the thick fibers 121 is less than the lower limit, the number of permeable pores to be formed in the adhesive film layer 105 decreases, resulting in deteriorated permeability, which in turn causes a deteriorated sound absorbing performance. Furthermore, if the use rate of the first fiber 122 is less than the lower limit, the sound absorbing effect of the sound absorbing nonwoven fabric layer 106 itself deteriorates, and therefore it is not preferable. Among other things, the combined mass ratio of the fibers constituting the sound absorbing nonwoven layer 106 is more preferably set to “thick fibers/first fibers”=“10/90 to 70/30.”

The amount of fibers constituting the sound absorbing nonwoven fabric layer 106 is preferably set to 150 to 1,000 g/m². If it is less than 150 g/m², sufficient sound absorbing effect cannot be obtained, and therefore it is not preferable. On the other hand, if it exceeds 1,000 g/m², it becomes difficult to secure sufficient permeability, resulting in deteriorated sound absorbing effect, and therefore it is not preferable.

As the nonwoven fabric configuration of the sound absorbing nonwoven fabric layer 106, needle punched nonwoven fabric and spanbond nonwoven fabric can be exemplified, though it is not specifically limited.

The adhesive film layer 105 is an adhesive layer of a thermoplastic resin film, and has a number of permeable pores formed by being contacted by the thick fibers 121. As the adhesive film, a polyethylene film and a polypropylene film can be exemplified, though it is not specifically limited.

The adhesive film layer 105 is preferably made of a resin film having resin composition in which filler is mixed to the thermoplastic resin. By mixing the filler, permeable pores can be more easily formed in the adhesive film layer 105 by being contacted by thick fibers. As the filler, calcium carbonate, barium sulfate, silica sand and magnesium hydrate can be exemplified, though it is not specifically limited.

The amount of the adhesive film layer 105 is preferably set to 50 to 300 g/m². If it is less than 50 g/m², sufficient bonding strength cannot be obtained, and therefore it is not preferable. On the other hand, if it exceeds 300 g/m², sufficient sound absorbing effects by resonance absorption of the adhesive film layer 105 cannot be obtained and it becomes difficult to form permeable pores in the adhesive film layer 105, and therefore it is not preferable.

The slip preventing resin layer 107 can be formed by, for example, applying the resin by a roller coating method or a spraying method. The amount of slip preventing resin layer 7 is preferably set to 50 to 150 g/m².

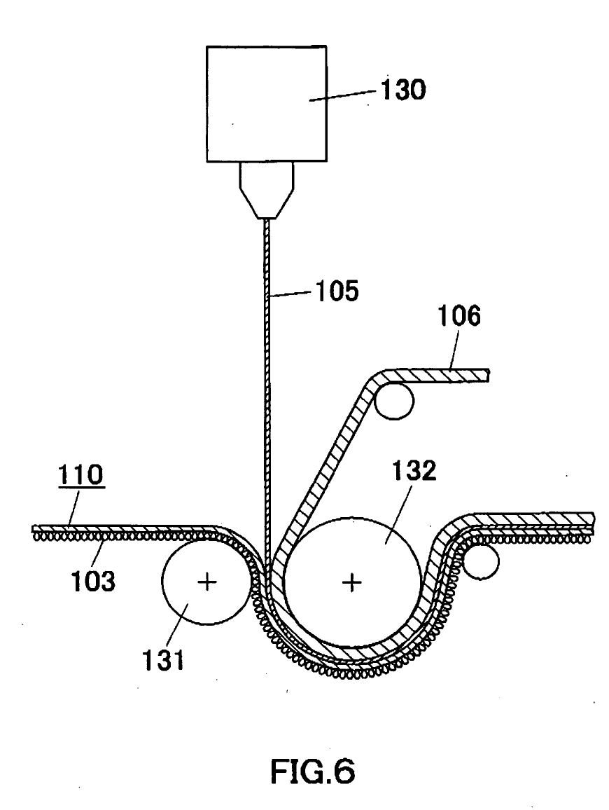

For example, the sound absorbing carpet 101 according to the second invention can be manufacture as follows. Initially, a skin surface member 110 in which pile 103 is embedded on the upper surface of the base fabric 102 and a precoat layer 104 is formed on the lower surface of the base fabric 102 by precoat processing is prepared. Then, as shown in FIG. 6, while extruding an adhesive film 105 from an extruder 130, the skin surface material 110 is supplied from the left direction in the figure and the sound absorbing nonwoven fabric 106 made of nonwoven fabric in which thick fibers 121 are upwardly protruded from the upper surface of the nonwoven fabric base layer 120 made of the thick fibers 121 and the first fibers 122 is supplied from the right direction in the figure. These are pressed by and between a pressure roller 131 and a cooling roller 132 in a state in which the adhesive film 105 is interposed between the surface skin material 110 and the sound absorbing nonwoven fabric 106. At this time, the nonwoven fabric 106 is disposed such that the thick fiber protruding side thereof comes into contact with the adhesive film 105, and the surface skin member 110 is disposed such that the precoat layer 104 thereof comes into contact with the adhesive film 105. Since the adhesive film 105 immediately after the extrusion from the extruder 130 is in a molten soft state, due to the pressing by and between the rollers 131 and 132, the surface skin material 110 and the sound absorbing nonwoven fabric 106 will be integrally bonded via the adhesive film 105. Thereafter, as shown in FIG. 6, this integrated member is transferred along the external peripheral surface of the cooling roller 132 to be cooled. Thus, a sound absorbing carpet 101 can be obtained.

### EXAMPLE 1

On a rear side of fabric in which pile 3 of nylon yarn in the amount of 450 g/m² was tufted in a base fabric 2 made of PET (polyethylene terephthalate) fabric spanbond nonwoven fabric in the amount of 120 g/m², a precoat layer 4 in the dry amount of 100 g/m² was formed by subjecting SBR latex to precoat processing. Thus, carpet fabric was obtained.

Next, while transferring the carpet fabric at a constant speed with the pile side facing downward, polyethylene power having an average diameter of 400 μm was applied to the carpet fabric at a spraying amount of 300 g/m². After heating the powder, a polyester needle punched nonwoven fabric 6 in the amount of 300 g/m² was superimposed thereon and pressed with cooling rollers. Thus, a carpet was obtained. The polyester needle punched nonwoven fabric 6 was 5 mm in thickness, the content rate of the round cross-sectional fibers was 70 mass %, and the content rate of the flat cross-sectional fibers with a flat rate of 25% was 30 mass %. The thickness of the round cross-sectional fiber was 3.3 desitex, and that of the flat cross-sectional fiber was 1.7 desitex.

Furthermore, on the rear side of the nonwoven fabric layer 6 of the obtained carpet, water repellent agent solution with density of 3 mass % was sprayed in the amount of 200 g/m² to impregnate the water repellent agent in the nonwoven fabric layer 6, and then they were heated and dried at 110° C. As the water repellent agent, water repellent agent “NK GUARD FSN-78” (fluorine series resin) manufactured by NICCA CHEMICAL CO. LTD. was used.

Thereafter, a slip preventing resin layer 7 was formed by spraying SBR resin on the rear surface of the nonwoven fabric layer 6, to thereby obtain a sound absorbing carpet.

### EXAMPLE 2

A sound absorbing carpet 1 was obtained in the same manner as in Example 1 except that nonwoven fabric in which the content rate of round cross-sectional fibers was 70 mass % and the content rate of flat cross-sectional fibers with a flat rate of 10% was 30 mass % was used as the polyester needle punched nonwoven fabric 6.

### EXAMPLE 3

A sound absorbing carpet 1 was obtained in the same manner as in Example 1 except that nonwoven fabric in which the content rate of round cross-sectional fibers was 70 mass % and the content rate of flat cross-sectional fibers with a flat rate of 43% was 30 mass % was used as the polyester needle punched nonwoven fabric 6.

### EXAMPLE 4

A sound absorbing carpet 1 was obtained in the same manner as in Example 1 except that nonwoven fabric in which the content rate of round cross-sectional fibers was 50 mass % and the content rate of flat cross-sectional fibers with a flat rate of 25% was 50 mass % was used as the polyester needle punched nonwoven fabric 6.

### EXAMPLE 5

A sound absorbing carpet 1 was obtained in the same manner as in Example 1 except that nonwoven fabric in which the content rate of round cross-sectional fibers was 95 mass % and the content rate of flat cross-sectional fibers with a flat rate of 25% was 5 mass % was used as the polyester needle punched nonwoven fabric 6.

### EXAMPLE 6

A sound absorbing carpet 1 was obtained in the same manner as in Example 1 except that the spray applied amount of water repellent solution was set to 67 g/m².

### EXAMPLE 7

A sound absorbing carpet 1 was obtained in the same manner as in Example 1 except that the spray applied amount of water repellent solution was set to 6.7 g/m².

### COMPARATIVE EXAMPLE 1

A sound absorbing carpet 1 was obtained in the same manner as in Example 1 except that nonwoven fabric in which the content rate of round cross-sectional fibers was 100 mass % (constituted only by round cross-sectional fibers) was used as the polyester needle punched nonwoven fabric 6.

TABLE 1

| | Sound absorbing nonwoven fabric layer | | | |
|---|---|---|---|---|
| | | | | Adhered |
| | | | Round | amount of |
| | Flat cross- | | cross-sectional | water repellent |
| | sectional fiber | | fiber | agent (dry |
| | Flat rate | Content rate | Content rate | condition) |
| | (%) | (mass %) | (mass %) | (g/m²) |
| Example 1 | 25 | 30 | 70 | 6 |
| Example 2 | 10 | 30 | 70 | 6 |
| Example 3 | 43 | 30 | 70 | 6 |
| Example 4 | 25 | 50 | 50 | 6 |
| Example 5 | 25 | 5 | 95 | 6 |
| Example 6 | 25 | 30 | 70 | 2 |
| Example 7 | 25 | 30 | 70 | 0.2 |
| Comp. Ex. 1 | | 0 | 100 | 6 |

Each sound absorbing carpet obtained as mentioned above was evaluated based on the following evaluation method.

<Sound Absorbing Rate Measuring Method>

In accordance with the vertical incident method according to JIS A1405, the sound absorbing rate was measured at each frequency.

<Water Repellent Evaluation Method>

Normal temperature water of 100 mL was calmly placed on the upper surface (pile surface) of the sound absorbing carpet, and left as it is for 10 minutes. 10 minutes later, the water penetration to the carpet rear surface was investigated.

(Evaluation Standard)

“⊚” . . . no water penetration to the carpet rear surface occurred, and the rear surface was in a dried state
“◯” . . . no water penetration to the carpet rear surface occurred, but the rear surface was humid, i.e., in a half-dried state
“Δ” . . . almost no water penetration to the carpet rear surface occurred, but the rear surface was wet,

“X” . . . water penetration to the carpet rear surface occurred.

TABLE 2

| | | | Example | Example | Example | Comp. |
|---|---|---|---|---|---|---|
| | | | 1 | 2 | 3 | Ex. 1 |
| Sound | 100 | Hz | 0.0101 | 0.0100 | 0.0102 | 0.0092 |
| absorbing | 125 | Hz | 0.0102 | 0.0113 | 0.0088 | 0.0089 |
| rate | 160 | Hz | 0.0131 | 0.0141 | 0.0128 | 0.0120 |
| | 200 | Hz | 0.0200 | 0.0204 | 0.0222 | 0.0197 |
| | 250 | Hz | 0.0233 | 0.0257 | 0.0255 | 0.0243 |
| | 315 | Hz | 0.0322 | 0.0330 | 0.0335 | 0.0321 |
| | 400 | Hz | 0.0389 | 0.0410 | 0.0412 | 0.0401 |
| | 500 | Hz | 0.0503 | 0.0521 | 0.0502 | 0.0485 |
| | 630 | Hz | 0.0630 | 0.0674 | 0.0634 | 0.0610 |
| | 800 | Hz | 0.0780 | 0.0871 | 0.0754 | 0.0723 |
| | 1000 | Hz | 0.0903 | 0.1170 | 0.0870 | 0.0810 |
| | 1250 | Hz | 0.1214 | 0.1481 | 0.1030 | 0.0980 |
| | 1600 | Hz | 0.1718 | 0.2008 | 0.1540 | 0.1210 |
| | 2000 | Hz | 0.2479 | 0.2827 | 0.2020 | 0.1720 |
| | 2500 | Hz | 0.3605 | 0.3828 | 0.2870 | 0.2270 |
| | 3150 | Hz | 0.4729 | 0.5140 | 0.4030 | 0.3240 |
| | 4000 | Hz | 0.6113 | 0.6794 | 0.5470 | 0.4850 |
| | 5000 | Hz | 0.7723 | 0.8368 | 0.7050 | 0.6260 |
| | 6300 | Hz | 0.8517 | 0.9218 | 0.7990 | 0.7080 |

| | | | | |
|---|---|---|---|---|
| Water repellent evaluation | ⊚ | ⊚ | ⊚ | ⊚ |

TABLE 3

| | | | Example | Example | Example | Example |
|---|---|---|---|---|---|---|
| | | | 4 | 5 | 6 | 7 |
| Sound | 100 | Hz | 0.0081 | 0.0084 | 0.0102 | 0.0102 |
| absorbing | 125 | Hz | 0.0115 | 0.0083 | 0.0088 | 0.0087 |
| rate | 160 | Hz | 0.0141 | 0.0112 | 0.0132 | 0.0137 |
| | 200 | Hz | 0.0202 | 0.0199 | 0.0200 | 0.0020 |
| | 250 | Hz | 0.0255 | 0.0234 | 0.0235 | 0.0235 |
| | 315 | Hz | 0.0321 | 0.0316 | 0.0325 | 0.0323 |
| | 400 | Hz | 0.0403 | 0.0401 | 0.0393 | 0.0394 |
| | 500 | Hz | 0.0511 | 0.0493 | 0.0511 | 0.0512 |
| | 630 | Hz | 0.0654 | 0.0621 | 0.0630 | 0.0632 |
| | 800 | Hz | 0.0864 | 0.0749 | 0.0782 | 0.0784 |
| | 1000 | Hz | 0.1010 | 0.0857 | 0.0909 | 0.0918 |
| | 1250 | Hz | 0.1322 | 0.0997 | 0.1218 | 0.1236 |
| | 1600 | Hz | 0.1880 | 0.1446 | 0.1735 | 0.1741 |
| | 2000 | Hz | 0.2635 | 0.1902 | 0.2515 | 0.2535 |
| | 2500 | Hz | 0.3746 | 0.2763 | 0.3610 | 0.3622 |
| | 3150 | Hz | 0.4945 | 0.3996 | 0.4778 | 0.4783 |
| | 4000 | Hz | 0.6480 | 0.5247 | 0.6201 | 0.6220 |
| | 5000 | Hz | 0.7940 | 0.6982 | 0.7713 | 0.7738 |
| | 6300 | Hz | 0.8811 | 0.7831 | 0.8525 | 0.8543 |

| | | | | |
|---|---|---|---|---|
| Water repellent evaluation | ⊚ | ⊚ | ⊚ | Δ |

As will be apparent from the above Table, each sound absorbing carpet according to Examples 1 to 7 of the first invention was excellent in sound absorbing performance and equipped with sufficient water repellent performance.

To the contrary, in the sound absorbing carpet according to Comparative Example 1 in which the sound absorbing nonwoven fabric layer was constituted only by round cross-sectional fibers, the sound absorbing performance was poor.

### EXAMPLE 8

On a rear side of fabric in which pile 103 of polypropylene yarn in the amount of 650 g/m² was tufted in base fabric 102 made of PET (polyethylene terephthalate) fabric spanbond nonwoven fabric in the amount of 100 g/m², a precoat layer 104 in the dry amount of 75 g/m² was formed by subjecting SBR latex to precoat processing. Thus, a surface skin material 110 was obtained.

Then, as shown in FIG. 6, while extruding a polyethylene film 105 in the amount of 250 g/m² from an extruder 130, the skin surface material 110 was supplied from the left direction in the figure and the polyester nonwoven fabric 106 in the amount of 300 g/m² was supplied from the right direction in the figure. These were pressed by and between a pressure roller 131 and a cooling roller 132 in a state in which the adhesive film 105 was interposed between the surface skin material 110 and the sound absorbing nonwoven fabric 106 to thereby integrally be bonded. Thus, a sound absorbing carpet was obtained. As the nonwoven fabric 106, nonwoven fabric having a nonwoven fabric base layer 120 made of thick fibers 121 of 150 desitex, first fibers 122 of 8 desitex and first fibers 122 of 4 desitex in which the thick fibers 121 were upwardly extended from the upper surface of the nonwoven fabric base layer 120 (see FIG. 5) was used. The combined mass ratio of the fibers constituting the nonwoven fabric 106 was 150 desitex thick fiber/8 desitex first fiber/4 desites first fiber=50/40/10. They were integrally bonded in a superimposed manner such that the thick fiber uprightly protruded side of the nonwoven fabric 106 came into contact with the polyethylene film 105. The polyethylene film 105 has a structure in which calcium carbonate was contained by 32 mass %.

### EXAMPLE 9

A sound absorbing carpet 101 was obtained in the same manner as in Example 8 except that, as the nonwoven fabric 106, nonwoven fabric having a nonwoven fabric base layer 120 made of thick fibers 121 of 30 desitex, first fibers 122 of 6 desitex and first fibers 122 of 4 desitex in which the thick fibers 121 were upwardly extended from the upper surface of the nonwoven fabric base layer 120 (see FIG. 5) and the combined mass ratio of the fibers constituting the nonwoven fabric 106 was 30 desitex thick fiber/4 desitex first fiber/4 desites first fiber=50/40/10, was used.

### EXAMPLE 10

A sound absorbing carpet 101 was obtained in the same manner as in Example 8 except that, as the nonwoven fabric 106, nonwoven fabric having a nonwoven fabric base layer 120 made of thick fibers 121 of 15 desitex, first fibers 122 of 8 desitex and first fibers 122 of 4 desitex in which the thick fibers 121 were upwardly extended from the upper surface of the nonwoven fabric base layer 120 (see FIG. 5) and the combined mass ratio of the fibers constituting the nonwoven fabric 106 was 15 desitex thick fiber/8 desitex first fiber/4 desites first fiber=60/30/10, was used.

### EXAMPLE 11

A sound absorbing carpet 101 was obtained in the same manner as in Example 8 except that, as the nonwoven fabric 106, nonwoven fabric having a nonwoven fabric base layer 120 made of thick fibers 121 of 100 desitex, first fibers 122 of 6 desitex and first fibers 122 of 4 desitex in which the thick fibers 121 were upwardly extended from the upper surface of the nonwoven fabric base layer 120 (see FIG. 5) and the combined mass ratio of the fibers constituting the nonwoven fabric 106 was 100 desitex thick fiber/6 desitex first fiber/4 desites first fiber=40/50/10, was used.

### EXAMPLE 12

A sound absorbing carpet 101 was obtained in the same manner as in Example 8 except that, as the nonwoven fabric 106, nonwoven fabric having a nonwoven fabric base layer 120 made of thick fibers 121 of 150 desitex and first fibers 122 of 4 desitex in which the thick fibers 121 were upwardly extended from the upper surface of the nonwoven fabric base layer 120 (see FIG. 5) and the combined mass ratio of the fibers constituting the nonwoven fabric 106 was 150 desitex thick fiber/4 desites first fiber=90/10.

### EXAMPLE 13

A sound absorbing carpet 101 was obtained in the same manner as in Example 8 except that, as the polyethylene film 105, a polyethylene film in the amount of 100 g/m² was used.

### COMPARATIVE EXAMPLE 2

A sound absorbing carpet 1 was obtained in the same manner as in Example 8 except that, as the nonwovern fabric 6, polyester needle punched woven fabric made of 6 desitex fiber in the amount of 90 mass % and 4 desitex fiber in the amount of 10 mass % was used.

### COMPARATIVE EXAMPLE 3

On a rear side of fabric in which pile 103 of polypropylene yarn in the amount of 650 g/m² was tufted in base fabric 102 made of PET (polyethylene terephthalate) fabric spanbond nonwoven fabric 2 in the amount of 100 g/m², a precoat layer 4 in the dry amount of 75 g/m² was formed by subjecting SBR latex to precoat processing. Thus, a surface skin meterila 110 was obtained.

Next, while transferring the surface skin member 110 at a constant speed with the pile side facing downward, polyethylene powder having an average diameter of 400 μm was applied to the surface skin member at a spraying amount of 300 g/m². After heating the powder, polyester needle punched nonwoven fabric (nonwoven fabric made of 6 desitex fiber in the amount of 90 mass % and 4 desitex fiber in the amount of 10 mass %) was superimposed thereon and pressed with cooling rollers. Thus, a sound absorbing carpet was obtained.

TABLE 4

| | Sound absorbing nonwoven fabric | | | | | | | Adhesive |
|---|---|---|---|---|---|---|---|---|
| | Thick fiber | | First fiber | | | | | film layer |
| | Thickness | Content rate | Thickness | Content rate | Thickness | Content rate | Amount | Amount |
| | (desitex) | (mass %) | (desitex) | (mass %) | (desitex) | (mass %) | (g/m²) | (g/m²) |
| Example 8 | 150 | 50 | 8 | 40 | 4 | 10 | 300 | 250 |
| Example 9 | 30 | 50 | 6 | 40 | 4 | 10 | 300 | 250 |
| Example 10 | 15 | 60 | 8 | 30 | 4 | 10 | 300 | 250 |
| Example 11 | 100 | 40 | 6 | 50 | 4 | 10 | 300 | 250 |
| Example 12 | 150 | 90 | — | — | 4 | 10 | 300 | 250 |
| Example 13 | 150 | 50 | 8 | 40 | 4 | 10 | 300 | 100 |
| Comp. Ex. 2 | — | — | 6 | 90 | 4 | 10 | 300 | 250 |
| Comp. Ex. 3 | — | — | 6 | 90 | 4 | 10 | 300 | *1 |

*1 . . . adhered with powder

Each sound absorbing carpet obtained as mentioned above was evaluated based on the following evaluation method.

<Sound Absorbing Rate Measuring Method>

In accordance with the vertical incident method according to JIS A1405, the sound absorbing rate was measured at each frequency.

<Permeability Measuring Method>

In accordance with JIS L1096 8.27.1 A method, the permeability (cm³/cm²/sec) was measured.

<Water Repellent Evaluation Method>

Normal temperature water of 100 mL was calmly placed on the upper surface (pile surface) of the sound absorbing carpet, and left as it is for 10 minutes. 10 minutes later, the water penetration to the carpet rear surface was investigated.

(Evaluation Standard)

“⊚” . . . no water penetration to the carpet rear surface occurred, and the rear surface was in a dried state
“◯” . . . no water penetration to the carpet rear surface occurred, but the rear surface was humid, i.e., in a half-dried state
“Δ” . . . almost no water penetration to the carpet rear surface occurred, but the rear surface was wet

“X” . . . water penetration to the carpet rear surface occurred

TABLE 5

| | | | Example | Example | Example | Example | Example |
|---|---|---|---|---|---|---|---|
| | | | 8 | 9 | 10 | 11 | 12 |
| Sound | 100 | Hz | 0.0092 | 0.0078 | 0.0084 | 0.0079 | 0.0102 |
| absorbing | 125 | Hz | 0.0089 | 0.0075 | 0.0083 | 0.0078 | 0.0088 |
| rate | 160 | Hz | 0.0120 | 0.0107 | 0.0112 | 0.0110 | 0.0128 |
| | 200 | Hz | 0.0197 | 0.0139 | 0.0141 | 0.0133 | 0.0222 |
| | 250 | Hz | 0.0243 | 0.0162 | 0.0169 | 0.0165 | 0.0255 |
| | 315 | Hz | 0.0321 | 0.0197 | 0.0207 | 0.0202 | 0.0335 |
| | 400 | Hz | 0.0401 | 0.0227 | 0.0232 | 0.0226 | 0.0412 |
| | 500 | Hz | 0.0485 | 0.0263 | 0.0275 | 0.0245 | 0.0502 |
| | 630 | Hz | 0.0610 | 0.0309 | 0.0330 | 0.0303 | 0.0634 |
| | 800 | Hz | 0.0723 | 0.0400 | 0.0420 | 0.0376 | 0.0754 |
| | 1000 | Hz | 0.0810 | 0.0582 | 0.0520 | 0.0541 | 0.0871 |
| | 1250 | Hz | 0.0980 | 0.0657 | 0.0654 | 0.0611 | 0.1032 |
| | 1600 | Hz | 0.1210 | 0.0748 | 0.0698 | 0.0768 | 0.1547 |
| | 2000 | Hz | 0.1720 | 0.0911 | 0.0846 | 0.1221 | 0.2020 |
| | 2500 | Hz | 0.2270 | 0.1176 | 0.1030 | 0.1645 | 0.2871 |
| | 3150 | Hz | 0.3240 | 0.1580 | 0.1290 | 0.2381 | 0.4039 |
| | 4000 | Hz | 0.4850 | 0.2000 | 0.1540 | 0.3166 | 0.5476 |
| | 5000 | Hz | 0.6260 | 0.2410 | 0.1820 | 0.4052 | 0.7050 |
| | 6300 | Hz | 0.7080 | 0.3000 | 0.2133 | 0.5074 | 0.7990 |

| | | | | | |
|---|---|---|---|---|---|
| Permeability | 8.2 | 2.8 | 1.1 | 4.0 | 10.9 |
| (cm³/cm²/sec) | | | | | |
| Water repellent | ⊚ | ⊚ | ⊚ | ⊚ | ⊚ |
| evaluation | | | | | |

TABLE 6

| | | | Example 13 | Comp. Ex. 2 | Comp. Ex. 3 |
|---|---|---|---|---|---|
| Sound | 100 | Hz | 0.0081 | 0.0084 | 0.0100 |
| absorbing | 125 | Hz | 0.0115 | 0.0083 | 0.0113 |
| rate | 160 | Hz | 0.0141 | 0.0111 | 0.0141 |
| | 200 | Hz | 0.0202 | 0.0144 | 0.0204 |
| | 250 | Hz | 0.0255 | 0.0169 | 0.0257 |
| | 315 | Hz | 0.0321 | 0.0206 | 0.0330 |
| | 400 | Hz | 0.0403 | 0.0237 | 0.0410 |
| | 500 | Hz | 0.0511 | 0.0273 | 0.0521 |
| | 630 | Hz | 0.0654 | 0.0318 | 0.0674 |
| | 800 | Hz | 0.0864 | 0.0403 | 0.0871 |
| | 1000 | Hz | 0.1010 | 0.0505 | 0.1070 |
| | 1250 | Hz | 0.1120 | 0.0651 | 0.1280 |
| | 1600 | Hz | 0.1680 | 0.0698 | 0.1775 |
| | 2000 | Hz | 0.2230 | 0.0744 | 0.2410 |
| | 2500 | Hz | 0.2990 | 0.0846 | 0.3173 |
| | 3150 | Hz | 0.4120 | 0.0856 | 0.4620 |
| | 4000 | Hz | 0.5870 | 0.0867 | 0.6339 |
| | 5000 | Hz | 0.7210 | 0.0877 | 0.8012 |
| | 6300 | Hz | 0.8070 | 0.0873 | 0.9011 |

| | | | |
|---|---|---|---|
| Permeability | 12.2 | 0 | 18.5 |
| (cm³/cm²/sec) | | | |
| Water repellent | ◯ | ⊚ | X |
| evaluation | | | |

As will be apparent from the above Table, each sound absorbing carpet according to Examples 8 to 13 of the second invention was excellent in sound absorbing performance and equipped with sufficient water repellent performance.

To the contrary, in the sound absorbing carpet according to Comparative Example 2 made by a nonwoven fabric layer not using thick fibers of 11 to 120 desitex, there was almost no permeability and it was poor in sound absorbing performance, though excellent water repellent performance was demonstrated. Furthermore, in the sound absorbing carpet according to Comparative Example 3 in which the surface skin material layer and the nonwoven fabric layer were integrally bonded, water was penetrated to the rear surface of the carpet.

It should be appreciated that the terms and descriptions herein are not used for limiting the scope of the invention, but used only for explaining embodiments of the present invention, and the invention is not limited to them. The invention permits any modifications and substitutions within the scope of the present invention defined by the appended claims.

What is claimed is:

1. A sound absorbing carpet, comprising:
a surface skin material layer;
a sound absorbing nonwoven fabric layer integrally laminated on a lower surface side of the surface skin material layer,
wherein flat cross-sectional fibers are used as at least a part of fibers constituting the sound absorbing nonwoven fabric layer.

2. The sound absorbing carpet as recited in claim 1, wherein a flat rate of the flat cross-sectional fiber is 5 to 40%.

3. The sound absorbing carpet as recited in claim 1, wherein round cross-sectional fibers and the flat cross-sectional fibers are used as fibers constituting the sound absorbing nonwoven layer, and wherein a content rate of the flat cross-sectional fibers with respect to a total amount of fibers constituting the sound absorbing nonwoven layer is 10 mass % or more but less than 100 mass %.

4. The sound absorbing carpet as recited in claim 3, wherein a thickness of the round cross-sectional fiber is 1.1 to 33 decitex, and wherein a thickness of the flat cross-sectional fiber is 1.1 to 17 decitex.

5. The sound absorbing carpet as recited in claim 1, wherein a thickness of the sound absorbing nonwoven layer is 1 to 20 mm.

6. The sound absorbing carpet as recited in claim 1, wherein an amount of fibers constituting the sound absorbing nonwoven fiber layer is 80 to 1,000 g/cm².

7. The sound absorbing carpet as recited in claim 1, wherein water repellent agent is adhered to at least a part of fibers constituting the sound absorbing nonwoven fiber layer.

8. The sound absorbing carpet as recited in claim 7, wherein an adherence amount of the water repellent agent (in a dry condition) is 1 to 20 g/m².

9. The sound absorbing carpet as recited in claim 1, wherein, as the surface skin material layer, carpet cloth in which pile is embedded in an upper surface of a base fabric having a precoat processed lower surface is used, and wherein the surface skin material layer and the sound absorbing nonwoven fabric layer are integrally bonded via a permeable adhesive resin layer of 30 to 500 g/m² formed by melting thermoplastic resin powder.

10. A sound absorbing carpet, comprising:
a surface skin material layer; and
a sound absorbing nonwoven fabric layer integrally laminated on a lower surface side of the surface skin material layer,
wherein round cross-section fibers and flat cross-sectional fibers with a flat rate of 5 to 40% are used as fibers constituting the sound absorbing nonwoven fabric layer,
wherein a content rate of the flat cross-sectional fibers with respect to a total amount of fibers constituting the sound absorbing nonwoven layer is 10 mass % or more but less than 100 mass %,
wherein a thickness of the round cross-sectional fiber is 1.1 to 33 decitex,
wherein a thickness of the flat cross-sectional fiber is 1.1 to 17 decitex,
wherein water repellent agent is adhered to at least a part of fibers constituting the sound absorbing nonwoven fiber layer, and
wherein an adherence amount of the water repellent agent (in a dry condition) is 1 to 20 g/m².

11. The sound absorbing carpet as recited in claim 10, wherein, as the surface skin material layer, carpet cloth in which pile is embedded in an upper surface of a base fabric having a precoat processed lower surface is used, and wherein the surface skin material layer and the sound absorbing nonwoven fabric layer are integrally bonded via a permeable adhesive resin layer of 30 to 500 g/m² formed by melting thermoplastic resin powder.

12. A sound absorbing carpet, comprising:
a surface skin material layer; and
a sound absorbing nonwoven fabric layer integrally bonded to a lower surface side of the surface skin material layer via an adhesive film layer made of thermoplastic resin,
wherein a part of fibers constituting the sound absorbing nonwoven fabric layer are constituted by thick fibers of 11 to 220 desitex, and
wherein the adhesive film layer is provided with permeable pores formed by being contacted by the thick fibers.

13. The sound absorbing carpet as recited in claim 12, wherein a part of the thick fibers are embedded in the adhesive film layer and tangled therewith.

14. The sound absorbing carpet as recited in claim 12, wherein thick fibers of 11 to 220 desitex and first fibers of 1 to 10 desitex are used as fibers constituting the sound aborbing nonwoven fabric layer.

15. The sound absorbing carpet as recited in claim 14, wherein the sound absorbing nonwoven fabric layer is made of nonwoven fabric in which the thick fibers are upwardly protruded from an upper surface of a nonwoven fabric base layer formed by the thick fibers and the first fibers.

16. The sound absorbing carpet as recited in claim 15, wherein a combined mass ratio of the fibers constituting the sound absorbing nonwoven layer is thick fibers/first fibers=5/95 to 99/1.

17. The sound absorbing carpet as recited in claim 12, wherein an amount of the sound absorbing nonwoven fiber layer is 150 to 1,000 g/m².

18. The sound absorbing carpet as recited in claim 12, wherein an amount of the adhesive film layer is 5 to 300 g/m².

19. The sound absorbing carpet as recited in claim 12, wherein the adhesive film layer contains the thermoplastic resin and filler.

20. The sound absorbing carpet as recited in claim 12, wherein, as the surface skin material layer, carpet cloth in which pile is embedded in an upper surface of a base fabric having a precoat processed lower surface is used.

21. The sound absorbing carpet as recited in claim 12, wherein a needle punched nonwoven fabric is used as the surface skin material layer.

22. A sound absorbing carpet, comprising:
a surface skin material layer; and
a sound absorbing nonwoven fabric layer integrally bonded to a lower surface side of the surface skin material layer via an adhesive film layer made of thermoplastic resin,
wherein the sound absorbing nonwoven fabric layer is made of nonwoven fabric in which thick fibers of 11 to 220 desitex are upwardly protruded from an upper surface of a nonwoven fabric base layer formed by the thick fibers and first fibers of 1 to 10 desitex,
wherein the adhesive film layer is provided with permeable pores formed by being contacted by the thick fibers,
wherein a part of the thick fibers are inserted in the adhesive film layer and tangled therewith,
wherein a combined mass ratio of the fibers constituting the sound absorbing nonwoven layer is thick fibers/first fibers=5/95 to 99/1.
wherein an amount of the sound absorbing nonwoven fiber layer is 150 to 1,000 g/m², and
wherein an amount of the adhesive film layer is 5 to 300 g/m².

23. A method of manufacturing a sound absorbing carpet, the method comprising:
superimposing nonwoven fabric in which thick fabrics of 11 to 220 desitex are used as a part of fibers constituting the nonwoven fabric, an adhesive film of thermoplastic resin obtained immediately after extrusion and a surface skin material in this order; and
pressing them by and between a pair of rollers.

24. The method of manufacturing a sound absorbing carpet as recited in claim 23, wherein, using nonwoven fabric in which thick fibers of 11 to 220 desitex are upwardly protruded from an upper surface of a nonwoven fabric base layer formed by the thick fibers and first fibers of 1 to 10 desitex as the sound absorbing nonwoven fabric layer, the nonwoven fabric, the adhesive film and the surface skin material are pressed by and between a pair of rollers in a state in which an upwardly protruded thick fiber side is in contact with the adhesive film.

25. The method of manufacturing a sound absorbing carpet as recited in claim 23, wherein a pressing roller is used as one of the pair of rollers and a cooling roller is used as the other of the pair of rollers.
